(19) United States
(12) Patent Application Publication
(10) Pub. No.: US 2011/0313831 A1
(43) Pub. Date: Dec. 22, 2011

(54) METHOD FOR PROVIDING ELECTRONIC COUPON SERVICE USING COMMUNICATION NETWORK, AND COMPUTER-READABLE RECORDING MEDIUM FOR STORING PROGRAM FOR EXECUTING THE METHOD

(75) Inventor: Young Bae Ku, Seoul (KR)

(73) Assignee: EBAY GMARKET CO., LTD., Seoul (KR)

(21) Appl. No.: 13/254,650

(22) PCT Filed: Mar. 2, 2010
(86) PCT No.: PCT/KR2010/001278

§ 371 Date: Sep. 2, 2011

(30) Foreign Application Priority Data
Mar. 2, 2009 (KR) 10-2009-0017667

(51) Int. Cl. G06Q 30/00

(52) U.S. Cl. 705/14.15

(57) ABSTRACT

The present invention provides a method for providing an electronic coupon service using a communication network, including: requesting a purchase for the electronic coupon product registered in an electronic coupon service-providing server via a purchaser terminal; enabling the electronic coupon service-providing server to generate first contract information containing a purchaser and a first contract number, using the electronic coupon service provider as a seller; and enabling the electronic coupon service-providing server to generate second contract information containing a second contract number, using the place at which the electronic coupon is used as a seller, and using the electronic coupon service provider as a purchaser, wherein said second contract information contains said first contract number.

### BACKGROUND

1. Field of the Invention

The present invention relates to a method for providing an electronic coupon service using a communication network, and more specifically, to a method for providing an electronic coupon service in which different contract numbers are generated when an electronic coupon is sold and when the electronic coupon is used and the contract number when the electronic coupon is used is associated with the contract number when the electronic coupon is sold.

2. Discussion of Related Art

Recently, with the rapid development of the Internet, electronic commerce in which articles are purchased online is gradually increasing. The electronic commerce deals with a variety of commodities, as well as daily articles, housewares, electronic goods, and the like.

Electronic commerce has been led by the development of communication networks. Most importantly though, a seller and a purchaser can now enjoy other advantages that were not obtainable from traditional commercial transaction systems.

That is, the seller cuts down facility cost, which may be reflected in product prices, since it is unnecessary for the seller to own a store and a separate large warehouse for storing products. Not only can the purchaser conveniently shop without the need to visit a store, but they can also purchase articles at lower prices.

Meanwhile, electronic coupon issuing service is newly emerging in the field of electronic commerce. A coupon is created to promote sales of commodities or advertise the commodities and shops' names. Coupons include discount coupons for discounting a given commodity by a given amount when a purchaser tries to purchase the commodity again, a commodity exchange coupon, a giveaway print coupon, and the like. Techniques for use of coupons in electronic commerce are disclosed in Korean Patent Nos. 837074, 749192, 594491, 779020, 840422, and 479726.

However, such electronic coupons have not been widely used yet. This is particularly because, in a scheme for providing an electronic coupon service, selling an electronic coupon and using the electronic coupon are complex.

In particular, in the case of a shopping mall that sells commodities or services, use of the electronic coupon has been attempted, but it is necessary to greatly change a conventional Internet shopping mall system. Accordingly, it is difficult to provide the electronic coupon service.

### SUMMARY OF THE INVENTION

The present invention has been invented in view of the foregoing circumstances, and an object of the present invention is to provide a more convenient scheme for providing an electronic coupon service.

Another object of the present invention is to provide a scheme of more conveniently applying and using electronic coupon service by introducing the same scheme as a commodity sale scheme in a general shopping mall server to provision of the electronic coupon service.

In order to accomplish the foregoing objects, according to a first of the present invention, there is provided a method for providing an electronic coupon service using a communication network, the method including: (a) requesting a purchase for an electronic coupon commodity registered in an electronic coupon service-providing server using a purchaser terminal; (b) generating, by the electronic coupon service-providing server, first contract information containing a first contract number with a purchaser, using an electronic coupon service provider as a seller; and (c) generating, by the electronic coupon service-providing server, second contract information containing a second contract number if the electronic coupon has been used, using an electronic coupon use place as a seller and the electronic coupon service provider as a purchaser, wherein the second contract information contains the first contract number.

Preferably, the electronic coupon service-providing server has an Internet web shopping mall function.

Preferably, the method may further include checking, by the electronic coupon service-providing server, whether an expiration date of the electronic coupon has passed at prescribed time intervals. If it is checked that the expiration date of the electronic coupon has passed, a settlement is made in the electronic coupon service-providing server, using the electronic coupon service-providing server as a seller and a purchaser.

Meanwhile, preferably, the first contract information contains the first contract number, a coupon number, a seller ID, a purchaser ID, and contract amount information, and the second contract information contains the first contract number, the second contract number, a coupon number, a seller ID, a purchaser ID, a contract amount, and settlement rate.

Preferably, in step (c), if the electronic coupon has been used, the use of electronic coupon may be handled as purchase for a commodity not exposed to the purchaser. For a general commodity or service, since a purchaser selects the commodity or service to purchase the commodity or service, the commodity or service is exposed to the purchaser. However, a step of performing a related process using the electronic coupon may be processed as the same contract case as the commodity or service purchase, but it is desirable that a scheme in which the commodity or service is not exposed is selected.

Meanwhile, in step (b), a delivery-related procedure for a paid electronic coupon commodity is automatically set as “delivering,” and in step (c), a delivery-related procedure for a used electronic coupon is automatically set as “delivered.” Accordingly, the step of performing a related process using the electronic coupon may be performed using the same contract scheme as in the commodity or service purchase.

According to another aspect of the present invention, there is provided a method for providing an electronic coupon service using a communication network, the method including the steps of: (a) requesting a purchase for an electronic coupon commodity registered in an electronic coupon service-providing server using a purchaser terminal; (b) generating, by the electronic coupon service-providing server, contract information with a purchaser, using an electronic coupon service provider as a seller; and (c) generating, by the electronic coupon service-providing server, contract information if the electronic coupon has been used, using an electronic coupon use place as a seller and the electronic coupon service provider as a purchaser.

According to another aspect of the present invention, there is provided a computer-readable recording medium having a program recorded thereon, the program enabling the above method for providing an electronic coupon service using a communication network to be executed by a computer.

### EFFECTS OF THE PRESENT INVENTION

According to the present invention, it is possible to more conveniently apply and use the electronic coupon service by introducing the same scheme as commodity sales in a general shopping mall server to provision of the electronic coupon service.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram showing an overall system for providing an electronic coupon service using a communication network according to an embodiment of the present invention;

FIG. 2 is a flowchart of a method of purchasing an electronic coupon using a purchaser terminal when providing the electronic coupon service using the communication network according to an embodiment of the present invention;

FIG. 3 is a flowchart of a method of using an electronic coupon in providing the electronic coupon service using the communication network according to an embodiment of the present invention; and

FIG. 4 is a flowchart of a method of checking whether an expiration date of an electronic coupon has passed when providing the electronic coupon service using the communication network according to an embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

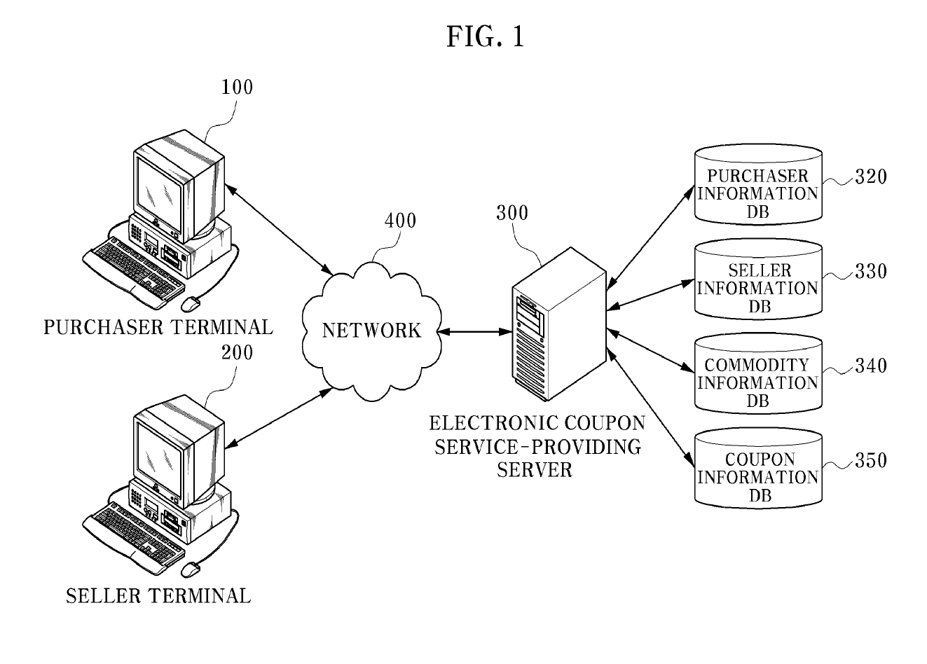

FIG. 1 is a block diagram showing an overall system for providing an electronic coupon service using a communication network according to an embodiment of the present invention.

Referring to FIG. 1, an overall system according to an embodiment of the present invention includes a purchaser terminal 100, a seller terminal 200, an electronic coupon service-providing server 300, a purchaser information database (DB) 320, a seller information DB 330, a commodity information DB 340, and a coupon management information DB 350.

Here, at least one purchaser terminal 100 and at least one seller terminal 200 are connected to the electronic coupon service-providing server 300 over a network 400.

Meanwhile, the electronic coupon service-providing server 300 preferably has an Internet web shopping mall function, but the present invention is not necessarily limited thereto. However, in the description of the embodiment, the electronic coupon service-providing server 300 is assumed to have both an electronic coupon service providing function and a web shopping mall function.

The network 400 may be wired or wireless Internet. Alternatively, the network 400 may be a core network integrated with a wired public network, a wireless mobile communication network, or mobile Internet. The network 400 has a global open computer network architecture that provides TCP/IP protocol and several services on an upper layer, i.e., Hyper Text Transfer Protocol (HTTP), Telnet, File Transfer Protocol (FTP), Domain Name System (DNS), and Simple Mail Transfer Protocol (SMTP).

Meanwhile, the purchaser terminal 100 and the seller terminal 200 are, for example, general computers such as desktop PCs or laptop PCs, but are not limited thereto. For example, the purchaser terminal 100 and the seller terminal 200 may be any type of wired/wireless communication devices capable of accessing the online shopping mall server 300 over the Internet 400 and using a bidirectional electronic commerce service. For example, the purchaser terminal 100 and the seller terminal 200 include mobile terminals such as cellular phones, Personal Communications Services (PCS) phones, or synchronous/asynchronous IMT-2000 (International Mobile Telecommunication-2000) that communicate via wireless Internet or mobile Internet. Alternatively, the purchaser terminal 100 and the seller terminal 200 may include any wired/wireless home/communication devices having a user interface for access to the online shopping mall server 300, such as Palm PCs (Personal Computers), personal digital assistants (PDAs), smart phones, wireless application protocol phones (WAP phones), and mobile gaming machines (mobile play-stations).

The purchaser terminal 100 may access the electronic coupon service-providing server 300 over the network 400 and use trade relaying service for commodities or services provided by the online shopping mall server according to a wired/wireless communication process using a communication interface, and provides electronic coupon service. A purchaser may subscribe as a customer who uses the service of the electronic coupon service-providing server 300 using the purchaser terminal 100. Purchaser information registered by the subscribed purchaser is stored in the purchaser information DB 320, and the coupon information is stored in the coupon information DB 350.

The seller terminal 200 may access the electronic coupon service-providing server 300 over the network 400, and use trade relaying service for commodities or services provided by the electronic coupon service-providing server 300 according to a wired/wireless communication process using a communication interface. A seller may subscribe as a customer who uses the service of the electronic coupon service-providing server 300 using the seller terminal 200. Seller information and commodity information registered by the subscribed seller may be stored in the seller information DB 330.

The seller terminal 200 is connected to the electronic coupon service-providing server 300 over the network 400. The seller terminal 200 may access a specific website, such as G Market (http://www.gmarket.co.kr), provided by a web server, and register commodities desired to be sold by a seller.

Meanwhile, the seller terminal 200 may access the web server of the electronic coupon service-providing server 300, subscribe as a member, and register commodities desired to be sold using a seller management program (e.g., G Market GSM program; not shown) that is downloaded and installed.

Further, the seller terminal 200 may be registered as an electronic coupon use place irrespective of registration of commodities or services. That is, the seller terminal 200 is a use place where the electronic coupon can be used and may build a cooperative relationship with a provider of the electronic coupon service-providing server 300 through a contract relationship in advance. Even when the seller terminal 200 is registered only as the electronic coupon use place, a seller ID is registered and related information is stored in the seller information DB 330. The seller terminal 200 of the seller serving as the electronic coupon use place acquires its seller ID such that the electronic coupon service-providing server 300 can easily provide the electronic coupon service using the online shopping mall function. The seller ID may be set by subscribing to the electronic coupon service-providing server 300 and providing seller information in advance or a business number of the electronic coupon use place may be used as the seller ID when the electronic coupon is used without taking a separate subscription procedure. The latter can be more conveniently implemented since it does not require a complex procedure.

The electronic coupon service-providing server 300 manages an online shopping mall over the network 400 to relay commodity trade between the seller and the purchaser. That is, the electronic coupon service-providing server 300 manages web pages for shopping mall management so that the purchaser purchases a desired commodity, by receiving a variety of commodities to be registered and sold by the seller from the seller terminal 200 over the network 400 and providing the variety of registered commodities to the purchaser terminal 100 through the web server connected to the network 400.

Further, the electronic coupon service-providing server 300 receives an electronic coupon purchase request from the purchaser terminal 100 and sells an electronic coupon in the name of the electronic coupon service-providing server in place of a previously contracted electronic coupon seller (use place). When an electronic coupon holder uses the electronic coupon, the seller terminal 200 registered as the electronic coupon use place performs settlement for use of the electronic coupon with the electronic coupon service-providing server 300. The electronic coupon service-providing server 300 can easily perform electronic coupon sales and settlement by processing electronic coupon sales for the purchaser terminal 100 and settlement for use of the electronic coupon with the seller terminal 200 as respective trade processes with separate contract numbers.

The electronic coupon service-providing server 300 may process payment for a commodity or an electronic coupon that the purchaser has decided to purchase and selected from a sale commodity list, perform a delivery process such as notifying the seller of information on the paid commodity so that the paid commodity can be delivered to the purchaser, and a process of tracking a position of a commodity being delivered or inquiring a tracking result, and manages necessary web pages. Since there is no delivery procedure for the electronic coupon, a delivery-related procedure is automatically processed as “delivering.”

The electronic coupon service-providing server 300 provides the electronic coupon provision service using the same system as a general commodity sale system, such that an electronic coupon can be provided without substantially changing a conventional shopping mall system.

Data information for electronic coupon transaction of a purchaser is transmitted via the purchaser terminal 100. For example, five electronic coupons of “breakfast at Gangnam station” are assumed to be purchased in a web page provided in the electronic coupon service-providing server 300. In this case, referring to Table 1, if the purchaser ID is “A,” the seller ID is “G Market,” not a general seller ID. The coupon is considered to be for sale in the electronic coupon service-providing server 300. Further, a contract number of a sale contract is “11111,” and a code of the sold coupon is stored together. In the case of a general shopping mall, the seller ID is an ID of an actually selling seller while in the case of the electronic coupon of the present invention, the seller ID is “G Market.”

TABLE 1

| Contract | Coupon | | Expiration | | | Purchaser | Selling |
|---|---|---|---|---|---|---|---|
| No. | Code | Seller ID | Date | Contract Date | Delivery | ID | price |
| 11111 | 1000001 | G Market | May 30, 2009 | Feb. 12, 2009 | Delivering | A | 50000 |
| | 1000002 | G Market | May 30, 2009 | Feb. 12, 2009 | Delivering | A | |
| | 1000003 | G Market | May 30, 2009 | Feb. 12, 2009 | Delivering | A | |
| | 1000004 | G Market | May 30, 2009 | Feb. 12, 2009 | Delivering | | |
| | 1000005 | G Market | May 30, 2009 | Feb. 12, 2009 | Delivering | A | |

Meanwhile, if the purchase contract is completed, in the case of a general commodity, delivery-related information is generated, while in the case of an electronic coupon, a delivery process is unnecessary. However, if the delivery information is used, the electronic coupon is processed through the same process as in conventional online shopping. That is, if purchase of the electronic coupon is terminated, delivery information is indicated as “delivering.” If the electronic coupon is used, the delivery information when the contract is made is indicated as “delivered.”

A process in which an electronic coupon holder uses an electronic coupon will now be described. If the electronic coupon holder uses the electronic coupon, this case is processed as a virtual contract case. The virtual contract case is not exposed in a website of the shopping mall, but is a case created for convenience of a process.

For example, when an electronic coupon holder uses two coupons at a store “Ga,” one coupon at a store “Na,” and two coupons at a store “Da,” a process as shown in Table 2 is performed.

TABLE 2

| | | | | | | | | Related | |
|---|---|---|---|---|---|---|---|---|---|
| Contract | Coupon | Seller | Purchaser | Expiration | Contract | | Contract | Contract | Settlement |
| No. | Code | ID | ID | Date | Date | Delivery | Amount | No. | Rate |
| 11112 | 1000001 | Ga | G Market | May 30, 2009 | Feb. 13, 2009 | Delivered | 20,000 | 11111 | 3% |
| | 1000002 | | | | | | | | |
| 11113 | 1000003 | Na | G Market | May 30, 2009 | Feb. 14, 2009 | Delivered | 10,000 | 11111 | 3.5% |
| 11114 | 1000004 | Da | G Market | May 30, 2009 | Feb. 16, 2009 | Delivered | 10,000 | 11111 | 2.5% |
| | 1000005 | | | | | | | | |

The electronic coupon holder may or may not be an electronic coupon purchaser. In most cases, a purchaser is unknown and, in this case, a purchaser ID is “G Market” for batch processing.

Meanwhile, when the electronic coupon is used, a new contract number is generated. Since the contract number is generated in units of transactions of a commodity, contract numbers “11112,” 11113,” and 11114″ are generated for three contracts in Table 2. The newly generated contract numbers are recoded with related contract numbers. That is, in a case created when the coupon is used, a related contract number is recorded with a contract number, a coupon number, a seller ID, a purchaser ID, and a contract amount. The related contract number contains a contract number when the electronic coupon is purchased. From this information, purchaser information, payment means information and the like can be confirmed, and the present contract case can be confirmed to be a virtual contract case.

If the electronic coupon is used, this case is considered as a new virtual contract case and a contract number is generated. If this contract number is associated with a contract number when the electronic coupon is purchased as the related contract number, information of a person who has purchased the used electronic coupon can be confirmed and information on the electronic coupon purchaser and the use place can be confirmed.

Further, if the electronic coupon is used and a new virtual contract number is generated, a settlement rate (fee) dependent on use date and use place is stored together therewith. This information is used to make a settlement according to a prescribed settlement rate between the electronic coupon use place and the provider of the electronic coupon service-providing server 300 after checking whether the expiration date of an electronic coupon has passed. It is understood that the provider of the electronic coupon service-providing server 300 can set different settlement rates (fees) according to electronic coupon use places to make the settlement.

The settlement rate may be set differently according to sellers by contracts made in advance. For the same seller, different settlement rates may be set according to categories. For example, if “Starbucks” is registered as the electronic coupon use place, settlement rates may be set differently according to categories such as beverage and confectionery of Starbucks.

Meanwhile, a process when a purchaser A uses two coupons at “Ga,” uses one coupon at “Na,” and does not use two other coupons, whose expiration date passes, is shown in Table 3.

TABLE 3

| | | | | | | | | Related | |
|---|---|---|---|---|---|---|---|---|---|
| Contract | Coupon | Seller | Purchaser | Expiration | Contract | | Contract | Contract | Settlement |
| No. | Code | ID | ID | Date | Date | Delivery | Amount | No. | Rate |
| 11112 | 1000001 | Ga | G Market | May 30, 2009 | Feb. 13, 2009 | Delivered | 20,000 | 11111 | 3% |
| | 1000002 | | | | | | | | |
| 11113 | 1000003 | Na | G Market | May 30, 2009 | Feb. 14, 2009 | Delivered | 10,000 | 11111 | 3.5% |
| 11114 | 1000004 | G Market | G Market | May 30, 2009 | — | — | 10,000 | 11111 | — |
| | 1000005 | | | | | | | | |

For an electronic coupon whose expiration date has passed, the process is performed with a contract made between “G Market” and “G Market” and a new contract number is generated when the electronic coupon is used. In this case, a settlement is made with G Market. In a case created when the coupon is used, a related contract number is recorded with a contract number, a coupon number, a seller ID, a purchaser ID, and a contract amount. A process when the purchaser A does not use any of five purchased coupons and the expiration date of the coupons has passed is shown in Table 4.

TABLE 4

| | | | | | | | | | |
|---|---|---|---|---|---|---|---|---|---|
| | | | | | | | | Related | |
| Contract | Coupon | Seller | Purchaser | Expiration | Contract | | Contract | Contract | Settlement |
| No. | Code | ID | ID | Date | Date | Delivery | Amount | No. | Rate |

| | | | | | | |
|---|---|---|---|---|---|---|
| 11112 | 1000001 | G Market | G Market | May 30, 2009 | 50,000 | 11111 |
| | 1000002 | | | | | |
| | 1000003 | | | | | |
| | 1000004 | | | | | |
| | 1000005 | | | | | |

For all electronic coupons whose expiration date has passed, a contract is considered to be made between “G Market” and “G Market,” and a new contract number is generated when the electronic coupon is used. In this case, a settlement is made with G Market.

The purchaser information DB 320 is a DB in which purchaser information registered by the subscribed purchaser, such as purchaser ID and password, contact information, shopping basket information, bid commodity information, knocked-down commodity information, bargained commodity information, paid commodity information, delivery information, purchase decision information, and the like are recorded and managed. The information may be read or updated with new purchaser information by the electronic coupon service-providing server 300.

The seller information DB 330 is a DB in which seller information registered by the subscribed seller (e.g., a seller ID, a password, and contact information), commodity information (e.g., name, price, brand, and feature of sale commodities), electronic coupon use information, seller-specific settlement rate, and the like are recorded and managed. The information may be read or updated with new seller information by the electronic coupon service-providing server 300.

The commodity information DB 340 is a DB in which information on a variety of commodities is recorded. The information may be read or updated with new seller information by the electronic coupon service-providing server 300.

The coupon information DB 350 is a DB in which electronic coupon-related information is stored through the seller terminal 200 or the electronic coupon service-providing server 300. For example, information such as a use place (seller) and expiration date for each electronic coupon is recorded. The information may be read and updated with new electronic coupon information by the electronic coupon service-providing server 300.

The DBs 320 to 360 may be implemented according to the object of the present invention, for example, by using a relational database management system (RDBMS) such as Oracle, Infomix, Sybase, or DB2 or an object-oriented database management system (OODBMS) such as Gemston, Orion, or O2, and have appropriate fields in order to realize their functions.

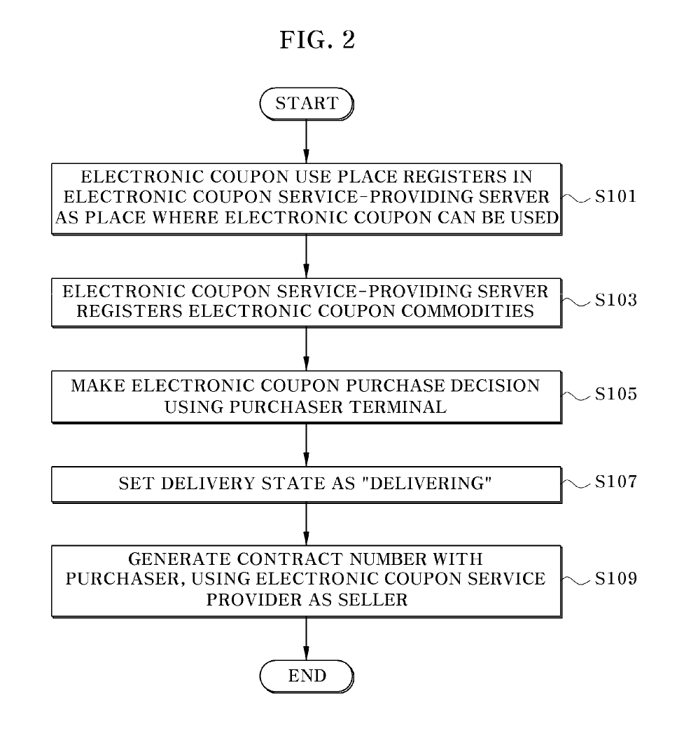

FIGS. 2 to 4 are flowcharts of a method for providing an electronic coupon service using a communication network according to an embodiment of the present invention.

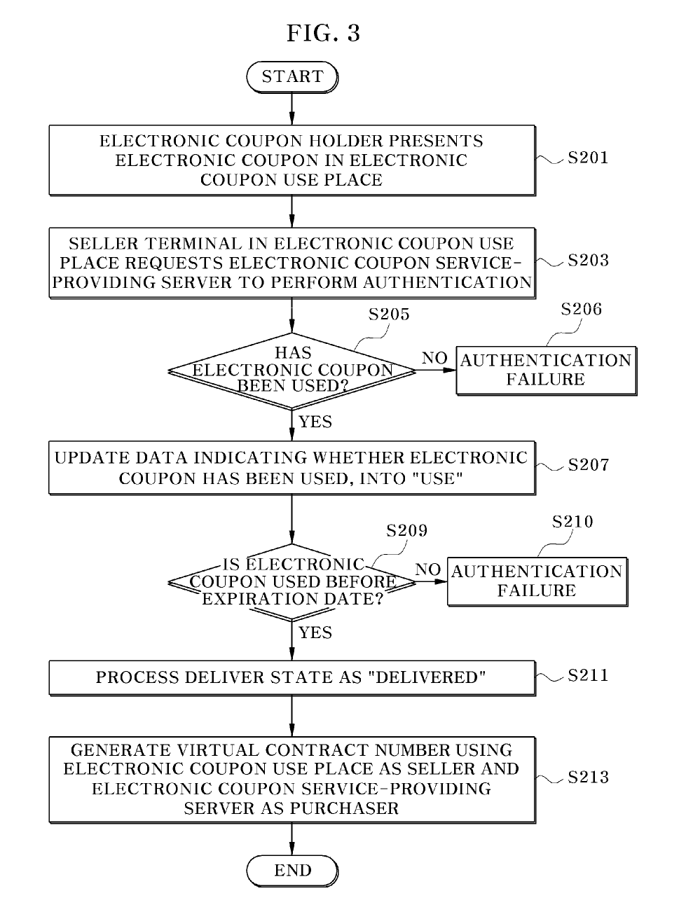

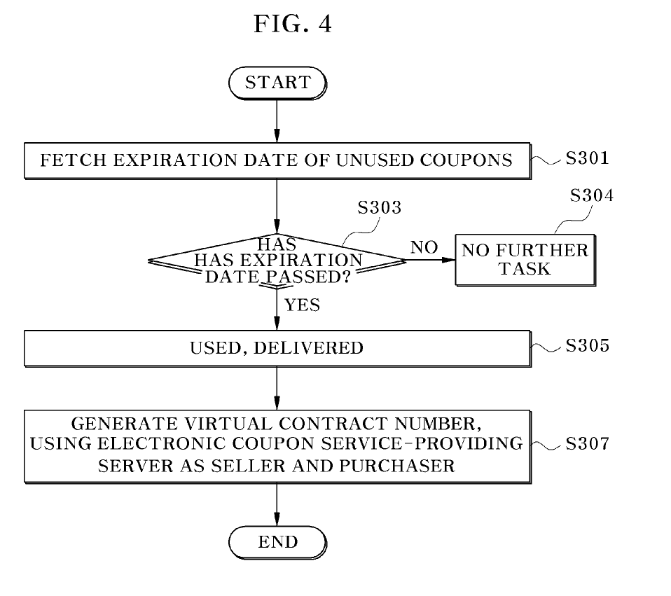

FIG. 2 is a flowchart of a method of purchasing an electronic coupon using a purchaser terminal when providing the electronic coupon service using the communication network according to an embodiment of the present invention. FIG. 3 is a flowchart of a method of using the electronic coupon when providing the electronic coupon service using the communication network according to an embodiment of the present invention. FIG. 4 is a flowchart of a method of checking whether an expiration date of the electronic coupon has passed when providing the electronic coupon service using the communication network according to an embodiment of the present invention.

### (Purchase of Electronic Coupon)

Referring to FIGS. 1 and 2, first, the electronic coupon use place and the provider of the electronic coupon service-providing server 300 are registered in advance so that the electronic coupon can be used (S101). Specifically, the electronic coupon use place and the provider of the electronic coupon service-providing server 300 perform advance preparation required to provide the electronic coupon, such as setting of the settlement rates according to categories by means of contracts made in advance.

Meanwhile, the electronic coupon use place may be registered as the seller ID in advance, as necessary. This step is not essential but may be selectively omitted. Since the electronic coupon can be purchased without the seller ID of the electronic coupon use place, the seller ID may be registered later, as described above.

Next, the electronic coupon service-providing server 300 may register electronic coupon commodities so that the electronic coupon commodities can be selected by purchasers (S103). The electronic coupon service-providing server 300 generates a contract number for a purchaser by setting the electronic coupon service provider as a seller in place of a previously contracted electronic coupon seller (use place). If the electronic coupon commodity is registered, related information is stored in the coupon information DB 350. In this case, information such as a use place (seller) and expiration date for each electronic coupon is recorded in the coupon information DB 350, and the related information may be set according to a contract made with the electronic coupon use place in advance.

Then, the purchaser makes a purchase decision (e.g., immediate purchase or shopping basket) using the purchaser terminal 100 (S105). Following the purchase decision, a normal procedure such as a payment process is performed, and a delivery-related procedure for the paid electronic coupon commodity is automatically processed as “delivering” (S107).

The electronic coupon service-providing server 300 then generates a contract number for a contract with the purchaser, using the electronic coupon service provider as a seller (S109). As shown in Table 1, when the purchase is contracted, related contract information (purchase information) containing contract number, coupon code, seller ID, expiration date, contract date, delivery, purchaser ID, and selling price is generated.

### (Use of Electronic Coupon)

FIG. 3 is a flowchart of a method of using an electronic coupon when providing the electronic coupon service using the communication network according to an embodiment of the present invention.

Referring to FIGS. 1 and 3, if the electronic coupon holder uses the electronic coupon in the electronic coupon use place (S201), the seller terminal in the electronic coupon use place requests the electronic coupon service-providing server to perform authentication (S203). The authentication may be performed, for example, by the seller terminal 200 requesting the electronic coupon service-providing server 300 to provide information such as a coupon number and confirming the information.

The seller terminal 200 then checks whether the electronic coupon has been used (S205). If the electronic coupon has been used, the authentication fails (S206). If the electronic coupon has not been used, the seller terminal 200 updates data indicating whether an electronic coupon has been used, into “use” (S207) so that the electronic coupon can be checked as a used coupon upon any subsequent use.

The seller terminal 200 then checks whether the electronic coupon is used before the expiration date (S209). If the electronic coupon is not used before the expiration date, the authentication fails (S206). If the electronic coupon is used before the expiration date, the process proceeds to a next step.

Next, the delivery-related procedure for the electronic coupon commodity is automatically processed as “delivered” (S211), and a virtual contract number is generated, using the electronic coupon use place as a seller and the electronic coupon service-providing server 300 as a purchaser (S213).

When the electronic coupon is used, a related contract number is recorded together with a new contract number, a coupon number, a seller ID, a purchaser ID, a contract amount and the like. The related contract number contains a contract number when the electronic coupon has been purchased. From this information, purchaser information, payment means information and the like can be confirmed and the present contract case can be confirmed to be the virtual contract case.

In this case, the seller ID may be generated when the electronic coupon use place previously subscribes as a seller in the electronic coupon service-providing server 300, or may be automatically generated, such as a business number.

### (Checking of Expiration Date)

FIG. 4 is a flowchart of a method of checking whether an expiration date of an electronic coupon has passed in providing the electronic coupon service using the communication network according to an embodiment of the present invention.

Checking whether the expiration date has passed may be performed on unused coupons at regular time intervals, for example, at a certain time of day by the electronic coupon service-providing server 300.

The electronic coupon service-providing server 300 fetches expiration dates of all unused coupons from the coupon information DB 350 at a designated time (S301).

The expiration date of each electronic coupon is checked (S303). If the expiration date has not passed, no further task is performed (S304). If the expiration date of the electronic coupon has passed, since the electronic coupon has not been used before the expiration date, the electronic coupon service-providing server 300 is considered to make a contract with the electronic coupon service-providing server 300.

First, data indicating whether an electronic coupon has been used is set to “used” and the electronic coupon is set to “delivered.” Then, a new contract number is generated using the electronic coupon service-providing server 300 as the seller and the purchaser. For example, a settlement is made in the electronic coupon service-providing server 300. For the electronic coupon whose expiration date has passed, a related contract number is recorded together with a contract number, a coupon number, a seller ID, a purchaser ID, a contract amount, and the like in the contract case.

Meanwhile, the method for providing an electronic coupon service using a communication network according to an embodiment of the present invention may be implemented as computer-readable code in a computer-readable recording medium. The computer-readable recording medium includes any type of recording device in which data that can be read by a computer system is stored.

For example, the computer-readable recording medium includes a ROM, a RAM, a CD-ROM, a magnetic tape, a hard disk, a floppy disk, a mobile storage device, a non-volatile memory (flash memory), optical data storage device, etc. Alternatively, the computer-readable recording medium may be implemented in the form of a carrier wave (e.g., Internet transmission).

Further, code that is distributed to computer systems connected via a computer communication network and can be read in a distribution scheme may be stored and executed in the computer-readable recording medium.

While the method for providing an electronic coupon service using a communication network according to a preferred embodiment of the present invention has been described, the present invention is not limited thereto. Various modifications can be made to the above-described exemplary embodiments of the present invention without departing from the spirit or scope of the invention. The present invention covers all such modifications provided they come within the scope of the appended claims and their equivalents.

What is claimed is:

1. A method for providing an electronic coupon service using a communication network, the method comprising:
(a) requesting a purchase for an electronic coupon commodity registered in an electronic coupon service-providing server using a purchaser terminal;
(b) generating, by the electronic coupon service-providing server, first contract information containing a first contract number with a purchaser, using an electronic coupon service provider as a seller; and
(c) generating, by the electronic coupon service-providing server, second contract information containing a second contract number if the electronic coupon has been used, using an electronic coupon use place as a seller and the electronic coupon service provider as a purchaser, wherein the second contract information contains the first contract number.

2. The method according to claim 1, further comprising checking, by the electronic coupon service-providing server, whether an expiration date of the electronic coupon has passed at prescribed time intervals.

3. The method according to claim 2, wherein if it is checked that the expiration date of the electronic coupon has passed, a settlement is made in the electronic coupon service-providing server, using the electronic coupon service-providing server as a seller and a purchaser.

4. The method according to claim 1, wherein the first contract information contains the first contract number, a coupon number, a seller ID, a purchaser ID, and contract amount information.

5. The method according to claim 1, wherein the second contract information contains the first contract number, the second contract number, a coupon number, a seller ID, a purchaser ID, a contract amount, and settlement rate.

6. The method according to claim 1, wherein in step (c), if the electronic coupon has been used, the use of electronic coupon is handled as purchase for a commodity not exposed to the purchaser.

7. The method according to claim 1, wherein in step (c), a seller ID of the seller is a business number of the electronic coupon use place.

8. The method according to claim 1, wherein in step (b), a delivery-related procedure for a paid electronic coupon commodity is automatically set as “delivering,” and
in step (c), a delivery-related procedure for a used electronic coupon is automatically set as “delivered.”

9. The method according to claim 1, wherein the electronic coupon service-providing server has an Internet web shopping mall function.

10. A method for providing an electronic coupon service using a communication network, the method comprising:
(a) requesting a purchase for an electronic coupon commodity registered in an electronic coupon service-providing server using a purchaser terminal;
(b) generating, by the electronic coupon service-providing server, contract information with a purchaser, using an electronic coupon service provider as a seller; and
(c) generating, by the electronic coupon service-providing server, contract information if the electronic coupon has been used, using an electronic coupon use place as a seller and the electronic coupon service provider as a purchaser.

11. The method according to claim 10, further comprising checking, by the electronic coupon service-providing server, whether an expiration date of the electronic coupon has passed at prescribed time intervals, wherein:
if it is checked that the expiration date of the electronic coupon has passed, a settlement is made in the electronic coupon service-providing server, using the electronic coupon service-providing server as a seller and a purchaser.

12. A computer-readable recording medium having a program recorded thereon, the program enabling a method according to any one of claims 1 to 11 to be executed by a computer.
